(19) United States
(12) Patent Application Publication
(10) Pub. No.: US 2022/0250530 A1
(43) Pub. Date: Aug. 11, 2022

(54) SUPPLY TANKER

(71) Applicant: GROUPE POURPRIX, Viliefranche-sur-Saone (FR)

(72) Inventor: Stephane HECKY, Fontaines Saint Martin (FR)

(21) Appl. No.: 17/617,684

(22) PCT Filed: May 11, 2020
(86) PCT No.: PCT/EP20/63031

§ 371 Date: Dec. 9, 2021

(30) Foreign Application Priority Data
Jun. 11, 2019 (FR) FR1906154

(51) Int. Cl. B60P 3/22

(52) U.S. Cl. CPC B60P 3/2245; B64F 1/28

(57) ABSTRACT

The supply tanker includes a chassis resting on axles and bearing a tank, a fuel-dispensing module, a cab and also a cherry picker. The chassis has at least two subassemblies articulated to one another. A first subassembly, arranged at the front, bears the cab and the cherry picker. Another subassembly, arranged behind the first subassembly, bears the dispensing module and the tank. The first subassembly includes an axle in front of which and below the axis of which there extends a platform supporting, juxtaposed transversely, the cab on one side and the cherry picker on the other side.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a refueling tank vehicle, essentially intended for use in the airport sector.

### 2. Description of Related Art Including Information Disclosed Under 37 CFR 1.97 and 37 CFR 1.98

Such a vehicle must have certain features due to its particular use, in particular with regard to sizing, since it must move between airplanes and under the wings thereof. In addition, it must have means allowing the operator to connect fuel supply lines under an airplane wing using a distribution module.

Therefore, tanker chassis for road use are currently used which are adapted for this particular usage, that is to say, their height is reduced, and a lifting platform is fitted thereto.

In addition to the fact that such a vehicle is not ergonomically optimized for the use for which it is intended, due to its origin, it has unused, and therefore unnecessary, features, which constitute an additional cost.

The object of this invention is to remedy this drawback by proposing a refueling tank vehicle designed specifically to meet the specifications.

### BRIEF SUMMARY OF THE INVENTION

The refueling tank vehicle according to the invention comprises a chassis resting on axles and carrying a tank, a fuel distribution module, a cab, and a lifting platform and is characterized in that said chassis has at least two sub-assemblies articulated to each other, a first of which, arranged at the front, carries said cab and said nacelle, while another, arranged behind said first sub-assembly, carries said distribution module and said tank, and in that said first sub-assembly comprises an axle in front of which and under the axis of which a platform extends supporting, juxtaposed transversely, on one side said cab and on the other side said nacelle.

The lowered platform allows for the cab to be practically level for the operator, as said operator must frequently access and exit it, and also allows for a large-amplitude, scissor-type lifting device the nacelle to be housed.

According to an additional feature of the refueling tank vehicle according to the invention, the sub-assembly which carries the tank is carried by at least one axle, which is a motor.

Due to the lowering of the cab, it is not possible to house the motor unit in the front sub-assembly; therefore, the propulsion is carried out from the rear sub-assembly.

The rear sub-assembly is driven by a motor unit which may be of any type, thermal, electric, or hybrid.

It should be noted that it is possible, in addition to the propulsion of the rear sub-assembly, for at least one of the front wheels to be driving, via, by way of non-limiting example, a wheel motor.

According to another additional feature of the refueling tank vehicle according to the invention, the axle of the front sub-assembly is a fixed axle.

According to another additional feature of the refueling tank vehicle according to the invention, the rear sub-assembly has a modular construction.

According to another additional feature of the refueling tank vehicle according to the invention, the rear sub-assembly comprises two parts, the second consisting of a trailer.

### BRIEF DESCRIPTION OF THE SEVERAL VIEWS OF THE DRAWINGS

The advantages and features of the refueling tank vehicle according to the invention will emerge more clearly from the description which follows, and which relates to the appended drawing, which represents several non-limiting embodiments thereof.

In the appended drawing:

FIG. 1 shows a perspective view of a refueling tank vehicle according to the invention.

FIG. 2 shows a perspective view from another angle of the same refueling tank vehicle.

FIG. 3 shows the same perspective view of the refueling tank vehicle in another configuration of use.

FIG. 4 shows a perspective view of a variant of the same refueling tank vehicle according to the invention.

### DETAILED DESCRIPTION OF THE INVENTION

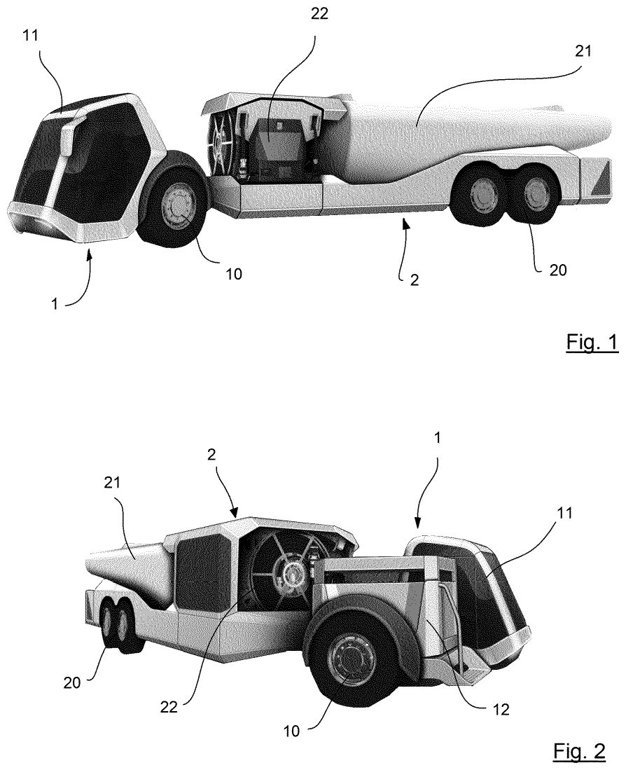

Referring to FIGS. 1, 2, and 3, it may be seen that a refueling tank vehicle according to the invention comprises an articulated chassis having two sub-assemblies, a front sub-assembly 1 and a rear sub-assembly 2.

The front sub-assembly 1 comprises an axle 10, a cab 1, and a nacelle 12 mounted on a lift 13.

The cab 1 is lowered, its base being lower than the axis of the axle 10, which allows for easy access.

The sub-assembly 2 comprises a double axle 20, a tank 21 and a fuel distribution module 22.

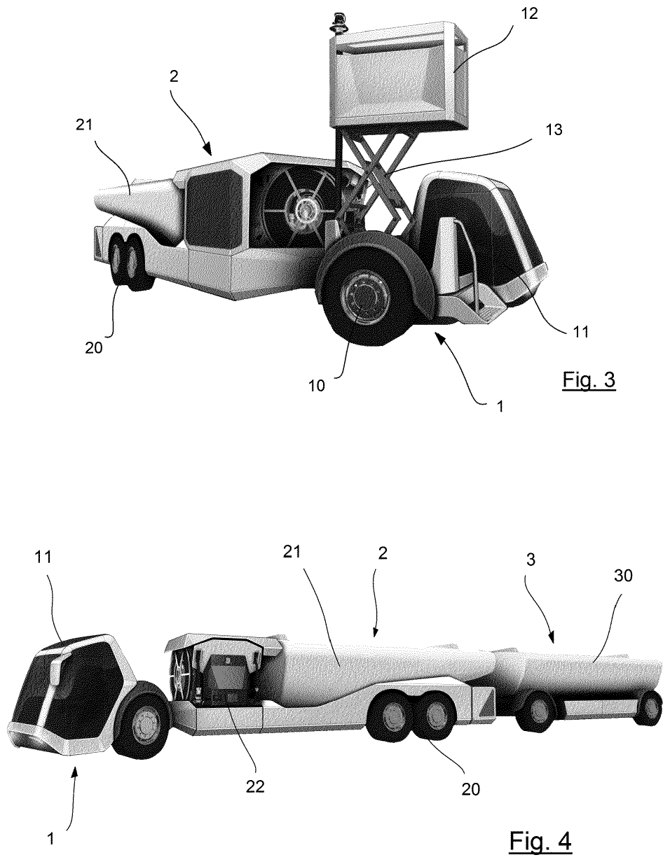

Referring to FIG. 4 the addition to the sub-assembly 2 of a trailer 3 carrying a tank 30 may be seen.

1. A refueling tank vehicle, comprising:
a chassis resting on axles and carrying a tank,
a fuel distribution module,
a cab, and
a lifting platform,
wherein said chassis has at least two sub-assemblies articulated to each other,
wherein a first, arranged at the front, carries said cab and said nacelle,
wherein another, arranged behind said first sub-assembly, carries said distribution module and said tank, and
wherein said first sub-assembly comprises an axle in front of which and under the axis of which a platform extends supporting, juxtaposed transversely, on one side said cab and on the other side said nacelle.

2. The refueling tank vehicle, according to claim 1, wherein the sub-assembly which carries the tank and is carried by at least one axle, which is a motor.

3. The refueling tank vehicle, according to claim 1, wherein the axle of the front sub-assembly is a fixed axle.

4. The refueling tank vehicle, according to claim 1, wherein the rear sub-assembly has a modular construction.

5. The refueling tank vehicle, according to claim 1, wherein the rear sub-assembly comprises two parts, the second consisting of a trailer.
